(19) United States
(12) Patent Application Publication
(10) Pub. No.: US 2012/0268551 A1
(43) Pub. Date: Oct. 25, 2012

(54) Image Interaction Device, Interactive Image Operating System, and Interactive Image Operating Method thereof

(76) Inventors: Ben Wu, Taipei City (TW); Ming-Che Ho, Kaohsiung City (TW); Yuan-Chang Chien, Taipei City (TW)

(21) Appl. No.: 13/442,838

(22) Filed: Apr. 9, 2012

Related U.S. Application Data
(60) Provisional application No. 61/476,777, filed on Apr. 19, 2011.

(30) Foreign Application Priority Data
Nov. 29, 2011 (TW) 100143698

(51) Int. Cl. H04N 7/15

(52) U.S. Cl. 348/14.03; 348/E07.083

(57) ABSTRACT

Before a large amount of information or messages is to be transmitted between image interaction devices, the information or messages are encoded into digital images to generate corresponding digital encoded images. When the digital encoded images are transmitted between the image interaction devices, the information or messages are transmitted along with the digital encoded images without introducing additional data transmission; and as a result, delay between the image interaction devices can be avoided, and real-time operations between the image interaction devices can be achieved.

### CROSS REFERENCE TO RELATED APPLICATIONS

This application claims priority of U.S. Provisional No. 61/476,777 filed on Apr. 19, 2011.

### BACKGROUND OF THE INVENTION

1. Field of the Invention

The present invention discloses an image interaction device, an interactive image operating system, and an interactive image operating method thereof, and more particularly, to an image interaction device, an interactive image operating system, and an interactive image operating method for encoding a data vector into a digital image to transmit information related to the digital image and to fulfill interaction between remote image interaction devices.

2. Description of the Prior Art

Please refer to FIG. 1, which schematically illustrates a conventional interactive gaming system 100, which includes a first image interaction device 110 and a second image interaction device 120. In FIG. 1, a user 130 uses the first image interaction device 110 to play an online game with a remote user 140 who uses the image interaction device 120. There is a network 150 disposed between the first image interaction device 110 and the second image interaction device 120, for transmitting messages or images between the first image interaction device 110 and the second image interaction device 120. The network 150 may be an internal network or an external network.

The first image interaction device 110 is capable of detecting a skeleton and a motion of the user 130 with the aid of a motion sensor 112, for generating and displaying a digital image 114 correspondingly. The second image interaction device 120 is also capable of detecting an skeleton and a motion of the user 140 with the aid of a motion sensor 122 for generating a digital image 116 correspondingly, and for transmitting the digital image 116 to the first image interaction device 110 via the network 150, so that the first image interaction device 110 is also capable of displaying both the digital images 114 and 116 simultaneously. Similarly, the second image interaction device 140 is also capable of displaying both the digital images 114 and 116 simultaneously. Commands issued from the user 130 for controlling the digital image 114 or commands issued from the user 140 for controlling the digital image 116 may also further be transmitted between the first image interaction device 110 and the second image interaction device 120 for playing an online interactive game.

However, while playing the online interactive game, large-scale data transmission is required on the network 150 for transmitting large amounts of digital images and commands so that the online interactive game can be played in a synchronous manner between the first image interaction device 110 and the second image interaction device 120. If the large-scale data transmission cannot be supported by the network 150, delay will be introduced between the first image interaction device 110 and the second image interaction device 120 so that synchronization of the online interactive game will fail. The quality of the online interactive game is reduced as a result.

### SUMMARY OF THE INVENTION

The claimed invention discloses an image interaction device. The image interaction device comprises an image fetching device, an image processing module, and an image transmitter. The image fetching device is utilized for fetching a digital image of an object. The image processing module is utilized for generating a data vector according to physical characteristics of the object in the digital image, and for encoding the data vector into the digital image to generate a digital encoded image. The image transmitter is utilized for outputting the digital encoded image to a network, so that an apparatus connected to the network is capable of displaying the digital image according to the data vector encoded within the digital encoded image.

The claimed invention discloses an interactive image operating system, which comprises a first image interaction device and a second image interaction device. The first image interaction device comprises an image fetching device, a first image processing module, and an image transmitter. The image fetching device is utilized for fetching a digital image of an object. The first image processing module is utilized for generating a data vector according to physical characteristics of the object in the digital image, and for encoding the data vector into the digital image to generate a digital encoded image. The image transmitter is utilized for outputting the digital encoded image. The second image interaction device comprises a receiver, a second image processing module, and a displaying device. The receiver is utilized for receiving the digital encoded image from the first image interaction device. The second image processing module is utilized for decoding the image decoded image to restore the data vector and the digital image. The displaying device is utilized for displaying the digital image according to the physical characteristics of the object decoded from the data vector.

The claimed invention further discloses an interactive image operating method. The interactive image operating method comprises a first image interaction device generating a data vector according to physical characteristics of an object fetched on a digital image; the first image interaction device encoding the data vector into the digital image for generating a digital encoded image; a second image interaction device decoding the digital encoded image for restoring the data vector and the digital image; and the second image interaction device displaying the digital image according to the physical characteristics decoded from the data vector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a conventional interactive gaming system.

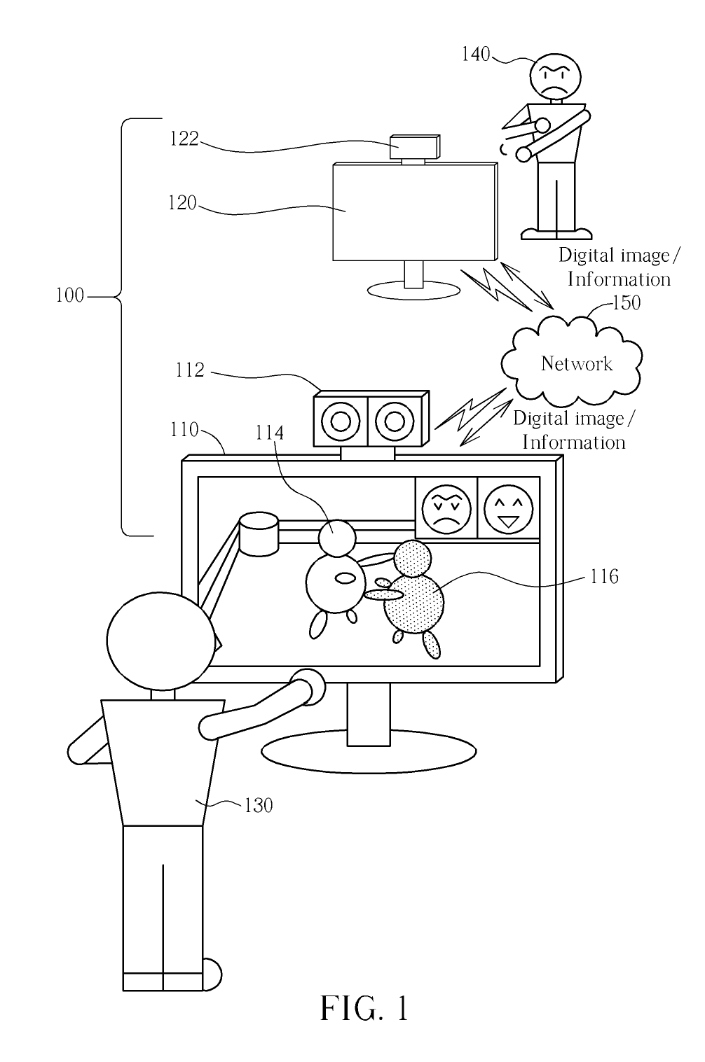

FIG. 2 schematically illustrates an interactive image operating system according to one embodiment of the present invention.

FIG. 3 illustrates a functional block diagram of the interactive image operating system 200 shown in FIG. 2.

FIG. 4 illustrates the interactive image operating method implemented on the interactive image operating system shown in FIG. 2 and FIG. 3 according to one embodiment of the present invention.

### DETAILED DESCRIPTION

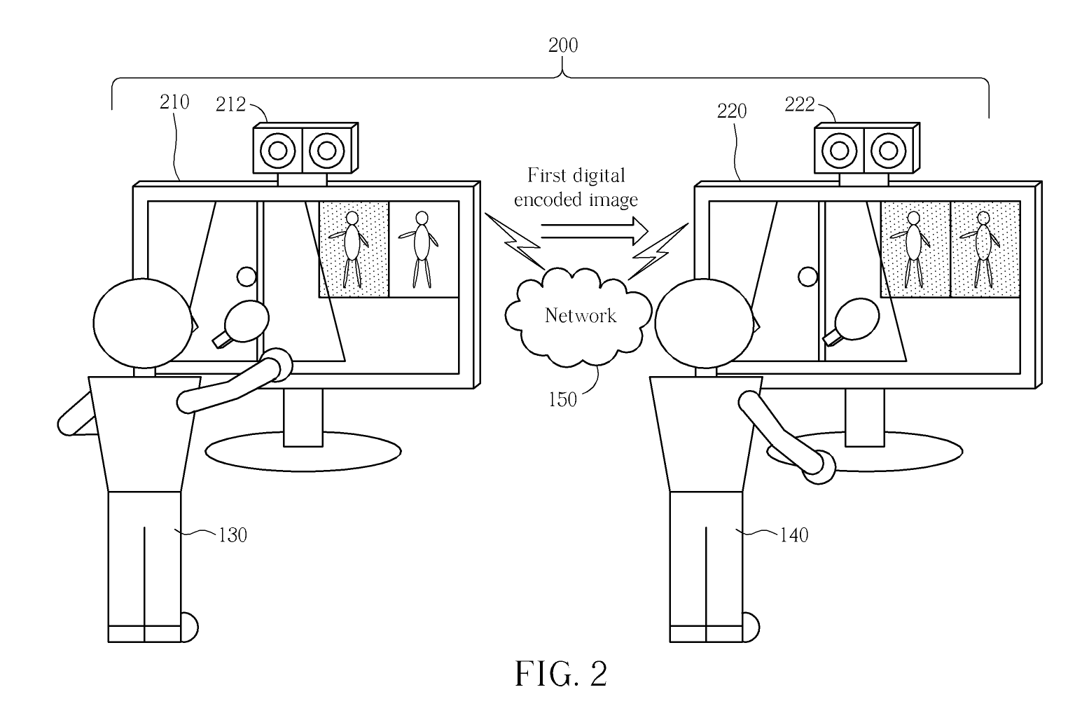

Please refer to FIG. 2, which schematically illustrates an interactive image operating system 200 according to one embodiment of the present invention. In FIG. 2, the user 130 uses a first image interaction device 210 to play an online interactive game with the remote user 140 who uses a second image interactive device 220. There is also a network 150 disposed between the first image interaction device 210 and the second image interaction device 220, where the network 150 may be an internal network or an external network. The primary difference between the interactive image operating system 200 shown in FIG. 2 and the interactive gaming system 100 lies in digital encoded images transmitted between the first image interaction device 210 and the second image interaction device 220, where the digital encoded images are generated by encoding a data vector including messages into digital images.

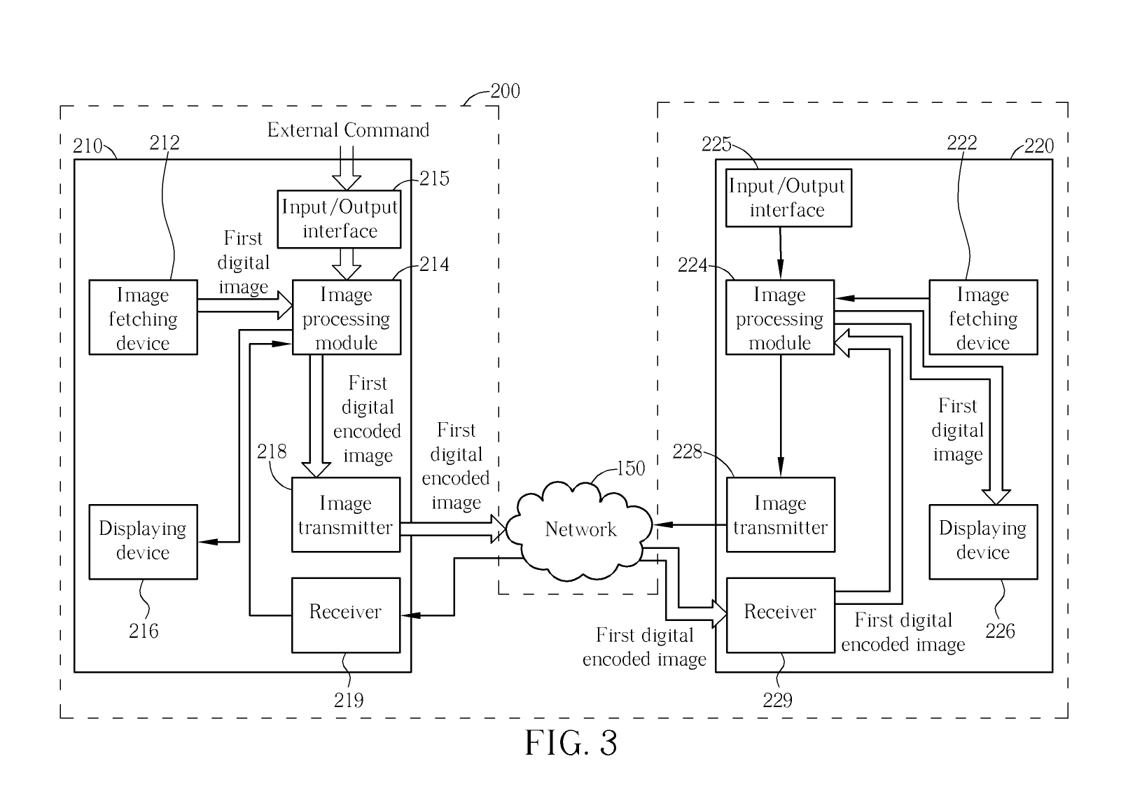

Please refer to FIG. 3, which illustrates a functional block diagram of the interactive image operating system 200 shown in FIG. 2, for disclosing elements of the interactive image operating system 200 and how the interactive image operating system 200 works in detail. As shown in FIG. 3, the first image interaction device 210 includes an image fetching device 212, an image processing module 214, an input/output (I/O) interface 215, a displaying device 216, an image transmitter 218, and a receiver 219; the second image interaction device 220 includes an image fetching device 222, an image processing module 224, an I/O interface 225, a displaying device 226, an image transmitter 228, and a receiver 229. Elements of the first image interaction device 210 and the second image interaction device 220 are basically the same. Connections and functions of the elements of the first image interaction device 210 and the second image interaction device 220 are also basically the same.

The following description of FIG. 3 primarily discloses details about how the first image interaction device 210 generates a first digital encoded image and transmits the digital encoded image to the second image interaction device 220, so that the second image interaction device 220 is capable of simultaneously displaying a first digital image restored by decoding the first digital encoded image and a second digital image generated by the second image interaction device 220, and is capable of displaying interactive functions between the first digital image and the second digital image. However, the second image interaction device 220 is also capable of generating a second digital encoded image and transmitting the second digital encoded image to the first image interaction device 210, so that the displaying device 216 is capable of simultaneously displaying the first digital image and the second digital image, and is capable of displaying interactive functions between the first digital image and the second digital image, where related details are not going to be further illustrated in FIG. 3 for brevity.

When interactive operations are performed by the first image interaction device 210 and the second image interaction device 220, such as an online interactive game, the image fetching device 212 fetches a first digital image related to the user 130 and transmits the first digital image to the image processing module 214. The image processing module 214 analyzes physical characteristics related to the user 130 and fetched on the first digital image for generating a data vector. The image processing module 214 encodes the data vector into the first digital image to generate a first digital encoded image, and transmits the first digital encoded image to the image transmitter 218. The image processing module 214 can be implemented with software, hardware, or a combination of both. The image transmitter 218 transmits the first digital encoded image to the second image interaction device 220 via the network 150.

When the second image interaction device 220 receives the first digital encoded image via the receiver 229, the receiver 229 transmits the first digital encoded image to the image processing module 224. The image processing module 224 is configured to decode the first digital encoded image, for restoring both the first digital image and the data vector previously encoded in the first digital encoded image. The image processing module 224 is also configured to transmit the first digital image and information included in the data vector to the displaying device 226. The image processing module 224 can be implemented with software, hardware, or a combination of both. Besides, the image fetching device 222 also fetches the second digital image related to the user 140, and transmits the second digital image to the displaying device 226 with the aid of processing of the image processing module 224. Finally, the displaying device 226 displays the first digital image according to the physical characteristics related to the user 130 and included in the data vector, and displays the second digital image at the same time, so that the first digital image and the second digital image may be displayed simultaneously on the displaying device 226 in a mutually-interactive manner. Similarly, the displaying device 216 may also display both the first digital image and the second digital image. Therefore, the users 130 and 140 can interact with each other with the aid of the first image interaction device 210 and the second image interaction device 220 included by the interactive image operating system 200.

In certain embodiments of the present invention, the image processing module 214 may include a device capable of analyzing an image of an object, such as a motion detector, an object detector, or an object tracker. The physical characteristics related to the user 130 and retrieved by image processing module 214 may include motion quantities of the user 130, a depth map of the user 130 in the first digital image, a skeleton of the user 130, and/or a gesture of the user 130 for operating the first digital image while playing the online interactive game, where the motion quantities may include a motion distance, a motion speed, or a motion direction of hands, feet, or body of the user 130.

In certain embodiments of the present invention, the image fetching devices 212 and 222 may be implemented by a device capable of fetching images of objects, such as a two-dimensional camera, a three-dimensional camera, and an IP camera. Therefore, considering physical characteristics of the user in certain embodiments of the present invention, the first digital image may be an avatar of the user 130, and the second digital image may be an avatar of the user 140.

In certain embodiments of the present invention, the data vector, which is encoded in the first digital encoded image, may include additional information, such as an external command, object attributes, rendering parameters and/or image parameters for setting the first digital image, where the user 130 is able to input the external command, the object attributes, the rendering parameters and/or the image parameters into the first image interaction device 210 with the aid of the I/O interface 215 connected to a keyboard, a mouse, a remote controller, or other types of controllers that the user 130 is able to access and use. The external command may be a partial operating command issued by the user 130 for controlling the first digital image, so that the displaying device 226 is capable of updating how the first digital image is displayed in response to the external command. For example, when the first digital image represents an avatar, the user 130 is able to issue an external command to change a specific costume of the first digital image, and clothes of the first digital image can be thus be replaced with the specific costume by the displaying device 226 in response to the external command from the user 130. The image parameters may include automatic white balance, automatic exposure, automatic focus, etc. of the first digital image. The image processing module 224 is capable of updating how the first digital image is displayed by the displaying device 226 in response to the external command and/or the image parameters.

In certain embodiments of the present invention, how the image processing module 214 encodes the data vector into the digital image may include hiding the data vector at a specific location in the first digital image, so that a partial image previously located at the specific location is replaced with the data vector, where a header can be further added for marking the location of hiding of the data vector. For example, the data vector may be hidden at a front end, a rear end, a high frequency region, a low-significant bit region, or combination of the above regions of an image sequence of the first digital image. Since the data vector can be hidden at locations that the user cannot easily observe, the quality of viewing of the first digital image by the user will not be reduced. However, the location of hiding of the data vector in the first digital image is not limited to the above-mentioned locations. That is, other locations that the user cannot easily observe may also be utilized for hiding the data vectors in embodiments of the present invention.

In embodiments of the present invention, the users 130 and 140 may be replaced with objects other than human beings, such as robots that can make motions.

With the aid of the interactive image operating system 200 disclosed in FIG. 2 and FIG. 3, when digital encoded images having encoded data vectors are transmitted between the first image interaction device 210 and the second image interaction device 220, other than digital images and plain messages transmitted in the conventional interactive gaming system 100, a degree of the data transmission is the same as data transmission of merely transmitting digital images, i.e. no additional data transmission is introduced. Therefore, delay introduced by overloaded data transmission between image interaction devices can be avoided, and the defect of the conventional interactive gaming system 100 can be neutralized with the aid of the interactive image operating system 200.

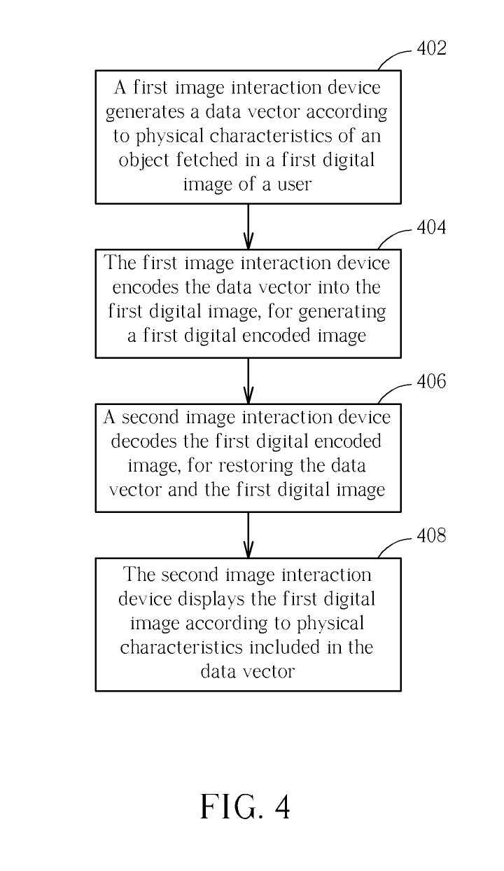

Please refer to FIG. 4, which illustrates the interactive image operating method implemented on the interactive image operating system 200 shown in FIG. 2 and FIG. 3 according to one embodiment of the present invention. As shown in FIG. 4, the interactive image operating method includes steps as follows:

Step 402: The first image interaction device 210 generates a data vector according to physical characteristics of an object fetched in a first digital image of the user 130.

Step 404: The first image interaction device 210 encodes the data vector into the first digital image, for generating a first digital encoded image.

Step 406: The second image interaction device 220 decodes the first digital encoded image, for restoring the data vector and the first digital image.

Step 408: The second image interaction device 220 displays the first digital image according to the physical characteristics included in the data vector.

Note that embodiments formed by adding the above-mentioned limitations to the steps shown in FIG. 4 or by taking reasonable combinations or permutations of the steps shown in FIG. 4 should also be regarded as embodiments of the present invention.

The present invention discloses an image interaction device, an interactive image operating system utilizing the image interaction device, and an interactive image operating method utilized by the interactive image operating system. With the aid of the abovementioned disclosure, when large-scale data transmission carrying information or messages is required between image interaction devices, the information or the messages can be encoded into digital images to be transmitted, so that the data transmission can be reduced, delay between the image interaction devices can be avoided, and real-time interactive operations between the image interaction devices can be fulfilled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image interaction device, comprising:
an image fetching device, for fetching a digital image of an object;
an image processing module, for generating a data vector according to physical characteristics of the object in the digital image, and for encoding the data vector into the digital image to generate a digital encoded image; and
an image transmitter, for outputting the digital encoded image to a network, so that an apparatus connected to the network is capable of displaying the digital image according to the data vector encoded within the digital encoded image.

2. The image interaction device of claim 1, wherein the physical characteristics of the object comprise a motion distance, a motion speed, a motion direction, a depth map, a skeleton, and/or a gesture of the object.

3. The image interaction device of claim 1, wherein the image processing module is configured to replace a partial image located at a specific location of the digital image with the data vector and to add a header for marking the specific location, for encoding the data vector into the digital image to generate the digital encoded image.

4. The image interaction device of claim 3, wherein the specific location is located at a front end, a rear end, a high-frequency image region, a low-significant bit region, or combination of the abovementioned locations in the digital image.

5. The image interaction device of claim 1, wherein the image fetching device is a two-dimensional camera, a three-dimensional camera, or a network camera.

6. The image interaction device of claim 1, further comprising:
a displaying device for displaying the digital image.

7. The image interaction device of claim 1, wherein the data vector further comprises an external command and/or an image parameter for setting how to display the digital image.

8. An interactive image operating system, comprising:
a first image interaction device, comprising:
an image fetching device, for fetching a digital image of an object;
a first image processing module, for generating a data vector according to physical characteristics of the object in the digital image, and for encoding the data vector into the digital image to generate a digital encoded image; and
an image transmitter, for outputting the digital encoded image; and
a second image interaction device, comprising:
a receiver, for receiving the digital encoded image from the first image interaction device;
a second image processing module, for decoding the image decoded image to restore the data vector and the digital image; and
a displaying device, for displaying the digital image according to the physical characteristics of the object decoded from the data vector.

9. The interactive image operating system of claim 8, wherein the physical characteristics of the object comprise a motion distance, a motion speed, a motion direction, a depth map, a skeleton, and/or a gesture of the object.

10. The interactive image operating system of claim 8, wherein the first image processing module is configured to replace a partial image located at a specific location of the digital image with the data vector and to add a header for marking the specific location, for encoding the data vector into the digital image to generate the digital encoded image.

11. The interactive image operating system of claim 10, wherein the specific location is located at a front end, a rear end, a high-frequency image region, a low-significant bit region, or combination of the abovementioned locations on the digital image.

12. The interactive image operating system of claim 8, wherein the image fetching device is a two-dimensional camera, a three-dimensional camera, or a network camera.

13. The interactive image operating system of claim 8, wherein the data vector further comprises an external command and/or an image parameter for setting how to display the digital image, and the displaying device is configured to update how to display the digital image according to the external command or the image parameter.

14. An interactive image operating method, comprising:
a first image interaction device generating a data vector according to physical characteristics of an object fetched on a digital image;
the first image interaction device encoding the data vector into the digital image for generating a digital encoded image;
a second image interaction device decoding the digital encoded image for restoring the data vector and the digital image; and
the second image interaction device displaying the digital image according to the physical characteristics decoded from the data vector.

15. The interactive image operating method of claim 14, further comprising:
the first image interaction device fetching the digital image.

16. The interactive image operating method of claim 14, further comprising:
the first image interaction device outputting the digital encoded image to the second image interaction device.

17. The interactive image operating method of claim 14, wherein the physical characteristics of the object comprise a motion distance, a motion speed, a motion direction, a depth map, a skeleton, and/or a gesture of the object.

18. The interactive image operating method of claim 14, further comprising:
the second image interaction device setting how to display the digital image according to an external command and/or an image parameter for operating the digital image.

19. The interactive image operating method of claim 14, wherein the first image interaction device encoding the data vector into the digital image for generating the digital encoded image comprises:
the first image interaction device replacing a partial image located at a specific location of the digital image with the data vector and adding a header for marking the specific location, for generating the digital encoded image.

20. The interactive image operating method of claim 14, wherein the specific location is located at a front end, a rear end, a high-frequency image region, a low-significant bit region, or combination of the abovementioned locations in the digital image.
